(19) United States
(12) Patent Application Publication
(10) Pub. No.: US 2007/0227953 A1
(43) Pub. Date: Oct. 4, 2007

(54) Machine for the Classification, Sieving and Separation of Non-Homogeneous Masses to Materials

(76) Inventor: Fabio Luigi Paron, Galliate-Novara (IT)

Correspondence Address: James V Costigan;Hedman & Costigan, 1185 Avenue of the Americas, New York, NY, 10036-2646, US

(21) Appl. No.: 11/596,261

(22) PCT Filed: May 17, 2005
(86) PCT No.: PCT/EP05/05485

§ 371 Date: Nov. 10, 2006

(30) Foreign Application Priority Data
May 20, 2004 (IT) MI2004A001008

(51) Int. Cl. B07B 1/14

(52) U.S. Cl. 209/272

(57) ABSTRACT

A machine for the classification, sieving and separation of non-homogeneous masses of materials comprises a feed (12) for such non-homogeneous masses (11) and a discharge (13) for a coarse portion of material (11A), respectively arranged at opposite ends of a selection bed (14) of the non-homogeneous masses (11) comprising a plurality of rotary elements (15) arranged adjacent to each other and suitable for determining the movement of the material, in which the rotary elements (15) can be spaced apart by a predefinable amount to define passage ports (16) for a portion of material (11B) of predetermined shape and size of the non-homogeneous masses and in which the rotary elements (15) have a cross section with cam profile (17, 18) or variable radius, in other words having a different cross section to the cylindrical section, the cam profile (17, 18) being suitable for developing a sinusoidal peripheral speed of the rotary elements (15).

The present invention refers to a machine for the classification, sieving and separation of non-homogeneous masses of materials.

Machines for the sieving of non-homogeneous masses of material made up for example of chips, shavings, fibres and grains of wood or of another material, are used to select the fractions with different grain size to be used as it is or to be conveyed to subsequent processing, such as gluing, refining or other treatments.

It is known to make separator devices, or sieve, with vibrating or oscillating net, as well as separator devices with rotating rollers or discs. The latter devices comprises rollers or shafts carrying discs, rotating in the same direction, which form a belt or bed onto which the non-homogeneous mass to be sieved is fed and made to advance during the separation operations.

The rollers or discs define interspaces, or ports, of predetermined size to separate the material selectively. In devices with discs the passage port is defined by interfacing surfaces of the disc-holding shafts and by the flat sides of the adjacent discs mounted on the shafts themselves.

In devices with rollers the passage port, defined between the cylindrical generatrices of the adjacent rollers, can be calibrated with greater precision.

The specific selection of the shapes of the cylindrical surfaces, consisting for example of crests and throats, or threads, with helical progression or else with pyramidal projections or other, allows the sieving of chips, particles and fibres, or of another material that is selected, to be optimised.

The main drawbacks of devices for the sieving of non-homogeneous masses of materials made according to the criteria outlined previously concern the wear of the rollers or of the discs, due to the rubbing both of the coarse material that is advanced on the belt and of the fine material that crosses the interspaces, as well as the sieving efficiency.

Indeed, the non-homogeneous material to be sieved quickly and with the maximum possible precision must not as far as possible be distributed on the belt both in the transversal direction and in the longitudinal direction, in other words in the direction of advance of the material on the rollers.

Indeed, during this advance movement on the roller belt of the non-homogeneous material, the fine portion of such material passes through the ports between the rollers or between the discs whereas the coarser portion advances until it is discharged downstream of the belt.

The length of the roller belt must therefore be sufficient to obtain the complete separation of the predetermined portion of non-homogeneous material. Long roller belts, however, obviously mean high bulk often incompatible with the space available.

Moreover, an incomplete separation of the predetermined portion of non-homogeneous material means a low quality end product and often also problems in the management and maintenance of the stations downstream of the separation device.

The purpose of the present invention is that of making a highly efficient machine for the classification, sieving and separation of non-homogeneous masses of materials.

Another purpose of the present invention is that of making a machine for the classification, sieving and separation of non-homogeneous masses of materials suitable for the treatment of non-homogeneous masses of various materials and with easily adjustable sieving size.

Another purpose according to the present invention is that of making a machine for the classification, sieving and separation of non-homogeneous masses of materials that is particularly simple and functional.

These purposes according to the present invention are accomplished by making a machine for the classification, sieving and separation of non-homogeneous masses of materials as outlined in claim 1. Further characteristics are foreseen in the dependent claims.

The characteristics and advantages of a machine for the classification, sieving and separation of non-homogeneous masses of materials according to the present invention shall become clearer from the following description, given as an example and not for limiting purposes, referring to the attached schematic drawings, in which:

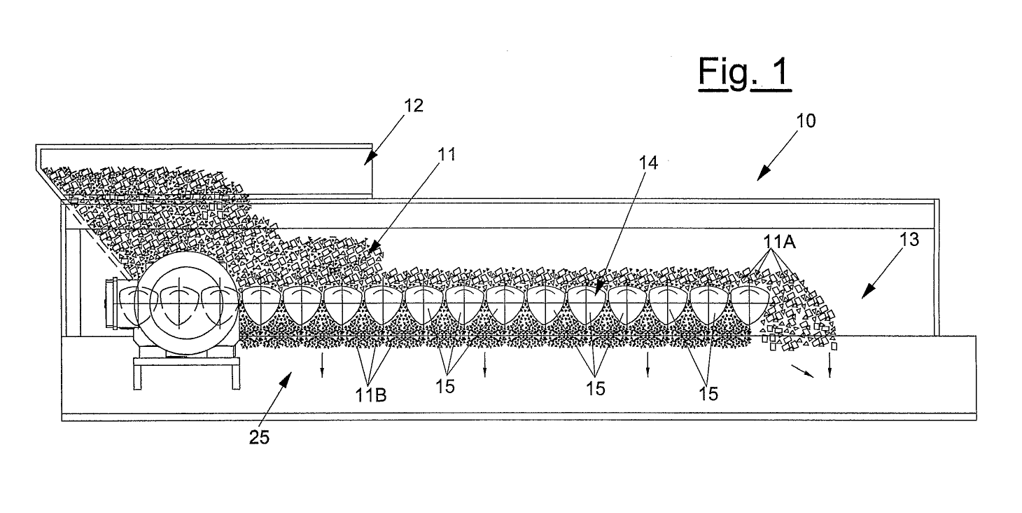

FIG. 1 is a top side partial section view of a machine for the classification, sieving and separation of non-homogeneous masses of materials according to the present invention.

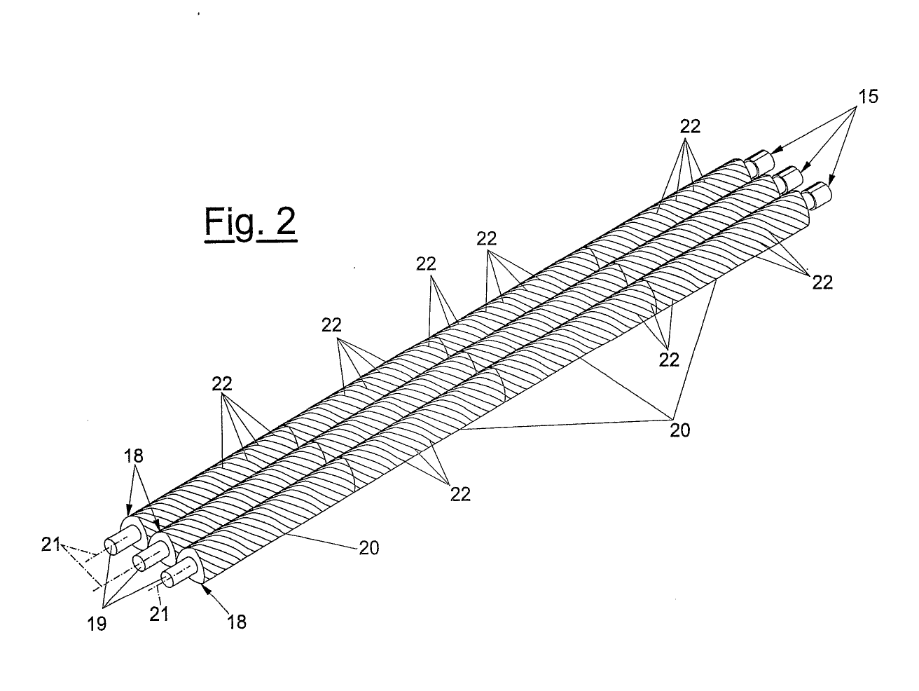

FIGS. 2 to 4 are schematic perspective views of rotary elements made up of a plurality of portions having a cross section with a tri-lobe profile arranged aligned along a rotation axis and respectively carrying a continuous helical surface incision, opposite helixes or else crossed helixes.

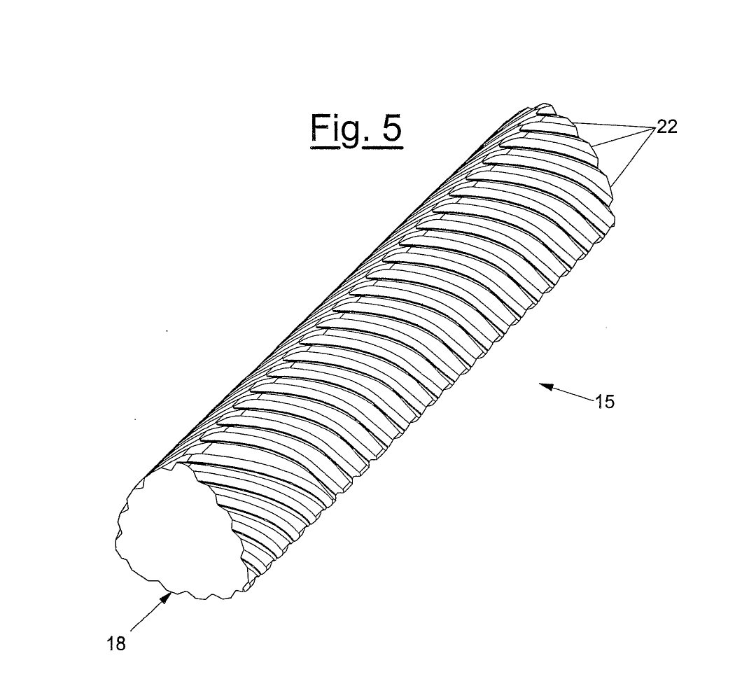

FIGS. 5 to 9 are schematic perspective views of some embodiments of the rotary elements having a profile with cam, tri-lobed or elliptical cross section.

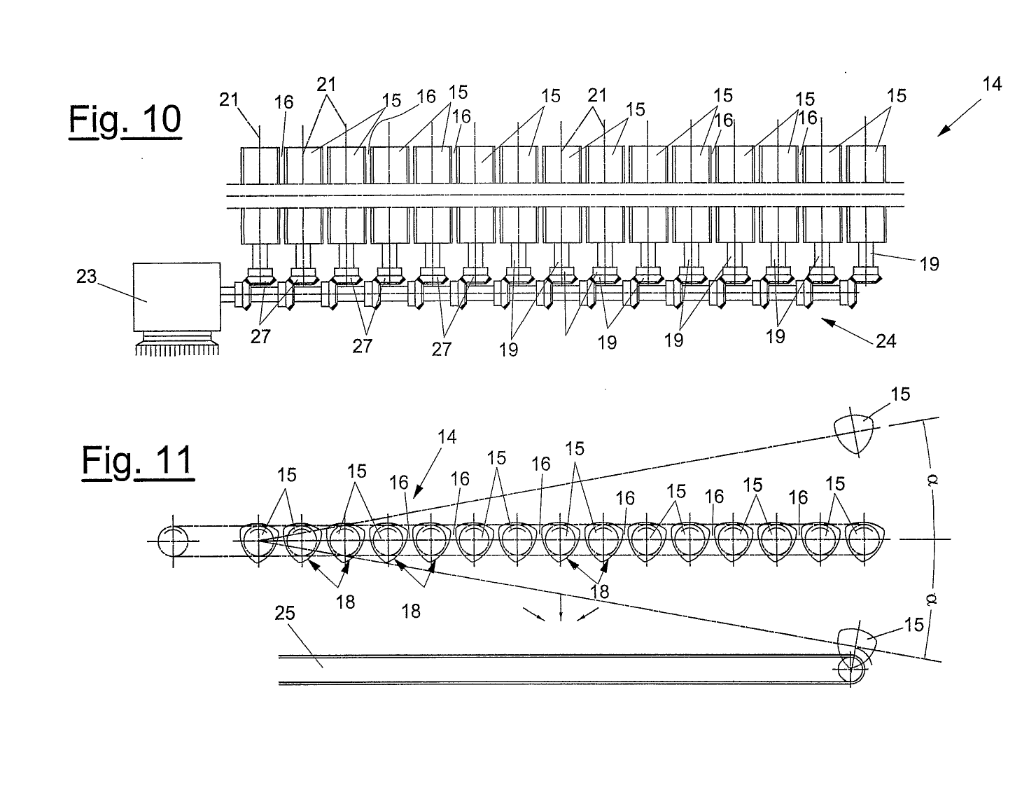

FIGS. 10 and 11 as well as 12 and 13 show schematic top plan views of a selection bed of a machine for the classification, sieving and separation of non-homogeneous masses of materials object of the present invention respectively arranged in a single plane or else comprising many branches at different heights.

With reference to FIG. 1, a machine for the classification, sieving and separation of non-homogeneous masses of materials is shown, wholly indicated with 10, which comprises a selection bed 14 of the non-homogeneous masses of material 11, a feeding area 12 for such non-homogeneous masses at a first end of the bed 14 and a discharge 13 of a coarse portion 11A of material at an opposite end.

By the term selection of material, hereafter, we mean both the sieving thereof and the consequent separation of the desired portion.

The materials, which can be classified, sieved and separated in the machine object of the present invention, can be wood-based material 11 in the form of chips, shavings, granules or fibres, mineral material, such as gravel, marble or other, or carbon as well as generically all non-homogeneous materials that require grain size or wet separation.

The selection bed 14 comprises a plurality of rotary elements 15, shown schematically in FIG. 1, arranged next to each other and able to be laterally distanced by a predefinable amount to define passage ports 16 for a portion of material of the non-homogeneous masses of predetermined shape and size 11B.

Under the selection bed 14 one or more collection spaces and/or belts 25 receive and/or feed the separated portion of material 11B to subsequent stations.

The rotary elements 15 comprise shafts 19, or substantially cylindrical cores, provided with one or more portions 20 having cross section with cam profile, or variable radius, aligned along a rotation axis 21. The portions 20 having cross section with cam profile thus have a different cross section to the cylindrical section, for example an elliptical cross section 17, or a substantially triangular or tri-lobed cross section 18.

The profile thus composed is able to develop a sinusoidal peripheral speed of the rotary elements 15, all preferably, but not necessarily, commanded in phase. Indeed, by commanding the rotary elements 15 in phase a selection effect, in other words a classification, sieving and separation effect, is obtained, within a narrow range of particles sizes. On the other hand, with command of the rotary elements not in phase a button-type selection is obtained within a range between a minimum and a maximum size value of the particles.

FIGS. 2 to 4 show, as a non-limiting example, some amongst the many possible embodiments, in which rotary elements 15 are each made up of four portions 20 having cross section with tri-lobe profile arranged aligned along the rotation axis 21. The rotary elements 15 of the machine for the classification, sieving and separation of non-homogeneous masses of materials according to the present invention can also be made up of a greater or smaller number of portions having cross section with cam profile, in such a way making the modularity of the selection bed 14.

The portions 20 having cross section with tri-lobed profile 17 can have an outer surface with whatever geometry, even variable. They can first of all be, in their simplest embodiment that is not shown, equipped with a smooth outer surface, as well as be equipped with an outer surface provided with incisions 22, or crests and troughs, with rectilinear, oblique, helical or crossed progression to form geometrically variable projections.

The rotary elements 15 shown in FIG. 2 are, for example, all provided with a continuous helical surface incision 22, in which the direction of the helix is the same along the entire rotary element 15 and for all of the adjacent rotary elements 15.

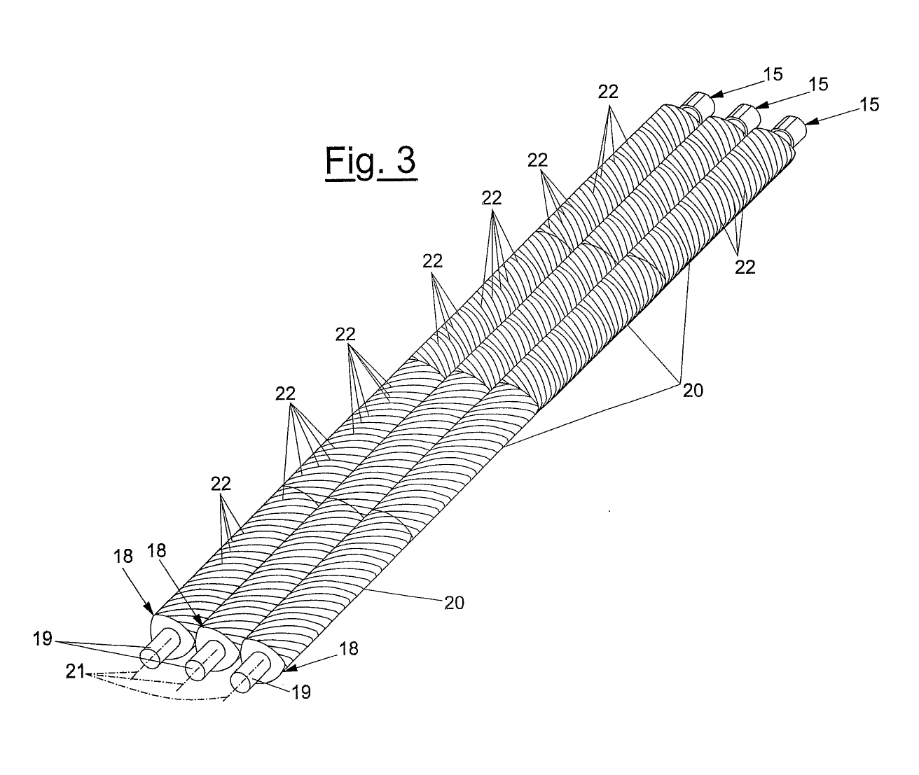

In FIG. 3, on the other hand, each rotary element 15 has opposite helixes on half of its length.

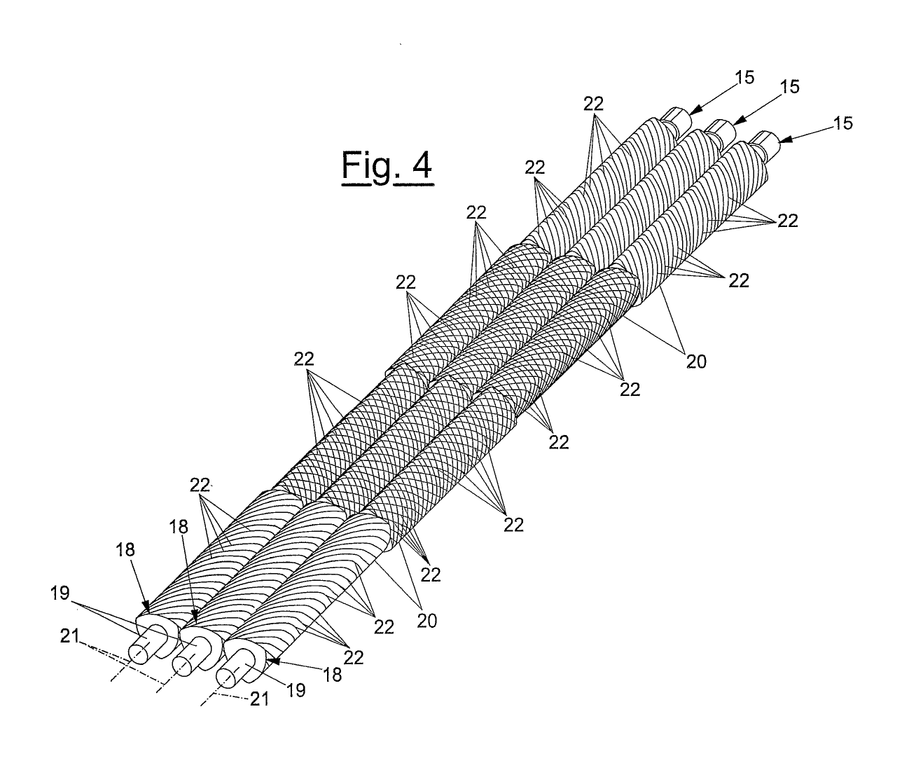

In FIG. 4, on the other hand, each rotary element 15 has four portions 20 having cross section with tri-lobed profile 18 aligned along the rotation axis 21, each of which has a different phasing, as well as different surface incision 22.

FIGS. 5 to 9 are schematic perspective views of some amongst the many possible embodiments of the rotary elements 15 having profile with cam, tri-lobed 18 or elliptical 17 cross section.

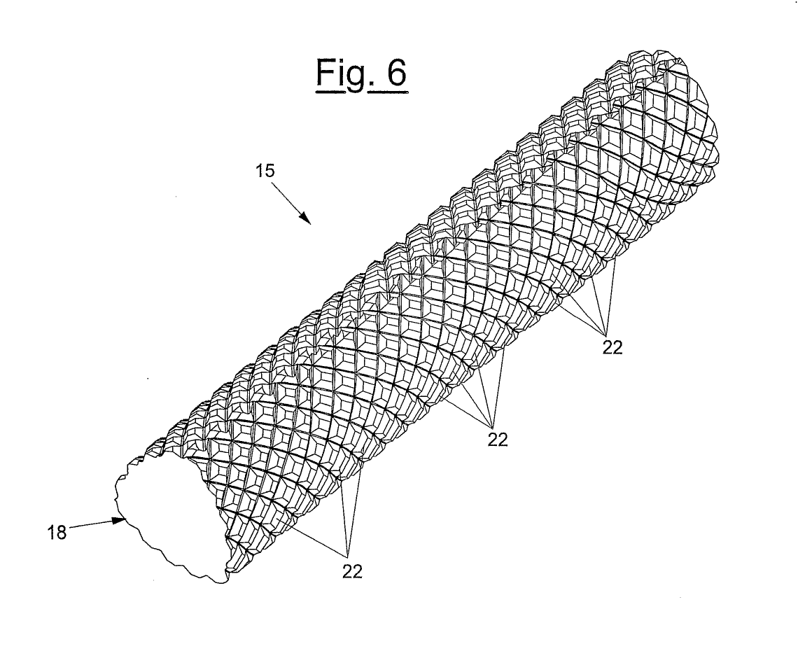

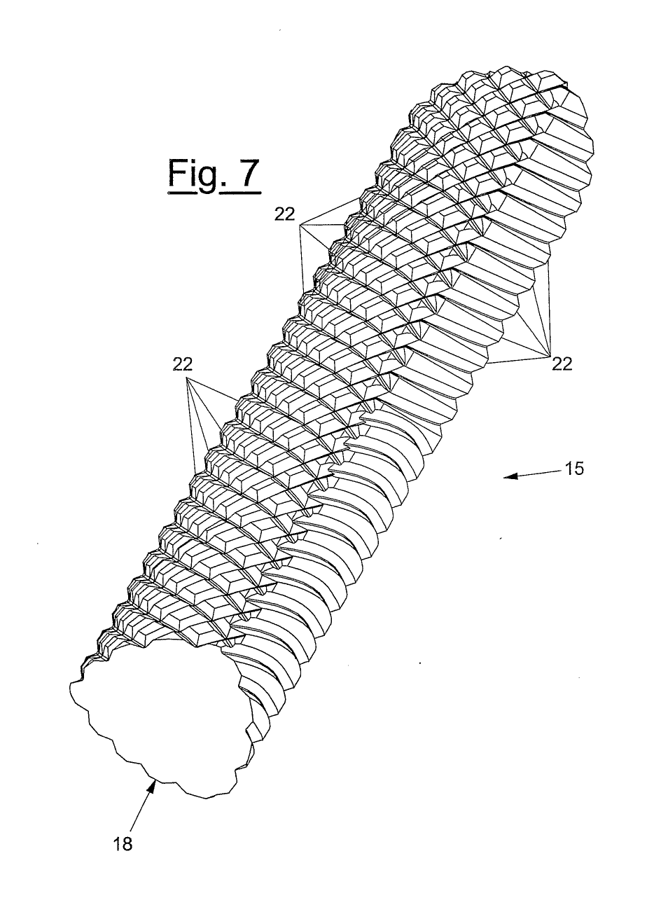

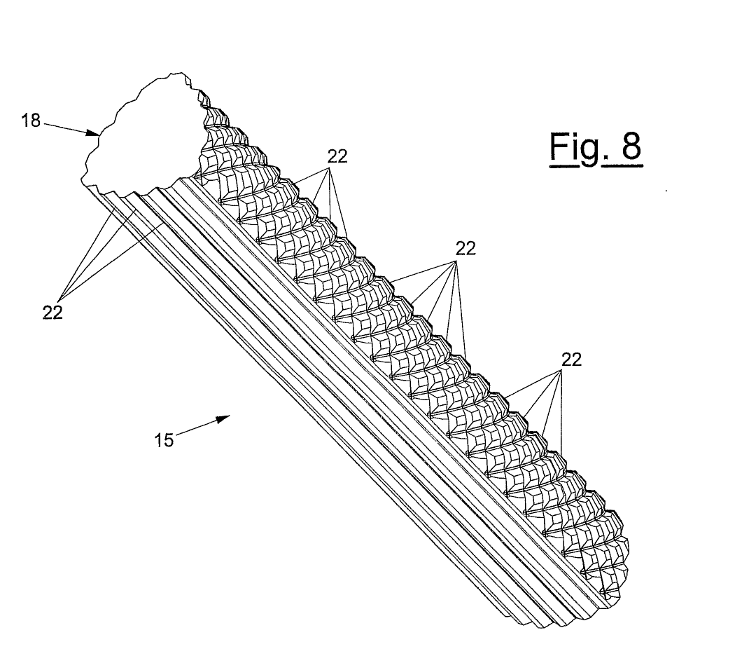

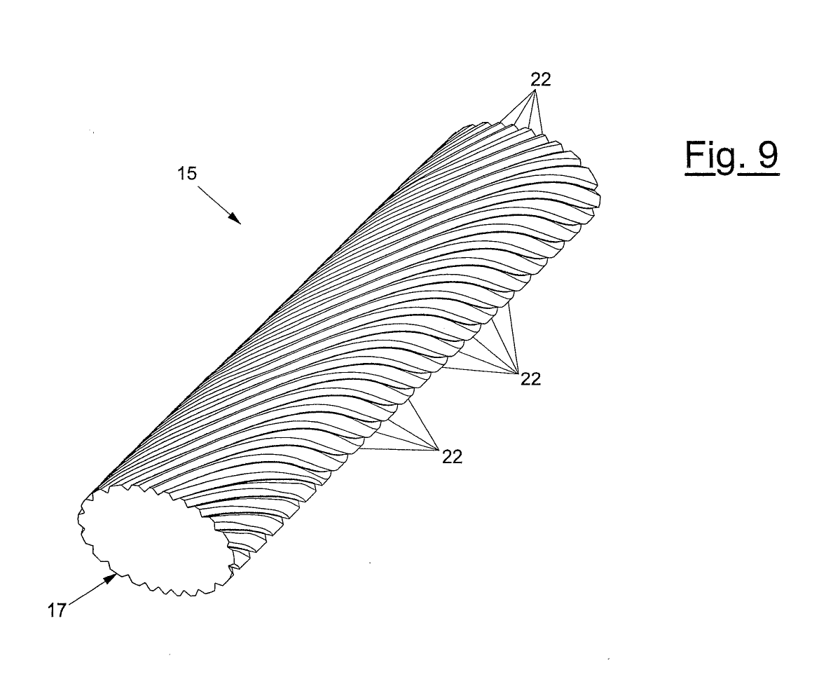

The helical incisions 22 (FIGS. 5 and 9), crossed helical incisions (FIGS. 6 and 7) and rectilinear incisions parallel to the rotation axis (FIG. 8) in the case of tri-lobed profiles 18 can be different on at least two of the three side faces as shown schematically in FIGS. 7 and 8.

As can be seen in FIG. 1 from the section carried out transversally through the selection bed 14, the distance between the rotation axes 21 of the rotary elements 15 can be less than the circle described in rotation by the outermost point of the cam profile, i.e. than the maximum radius of the cam profile.

Moreover, an area shared by two adjacent rotary elements 15 is cyclically variable, since the rotation axes 21 are also kept at a constant distance.

To adjust the size of the particles or portion 11B of non-homogeneous masses to be classified, sieved and separated on the bed 14, the rotary elements 15 can be laterally distanced through adjustment means (not shown and known to the man skilled in the art). In particular, the rotary elements 15 can be distanced according to a straight line, to form a plane with rectilinear progression, or else according to a broken line. In this second case (not shown), the adjacent rotary elements 15, arranged at different heights, define a plane with sinusoidal progression.

FIGS. 10 and 11 as well as 12 and 13 respectively show schematic plan and top views of a selection bed 14 of a machine for the classification, sieving and separation of non-homogeneous masses of materials object of the present invention arranged in a single plane or else comprises many branches 14A, 14B, 14C at different heights.

In both cases the selection bed 14 or the branches 14A, 14B, 14C can be inclined with respect to a horizontal plane by an angle equal to +/−α.

In the figures, in a position below the bed 14, a discharge space or belt 25 is shown for the particles or portions of material selected 11B through the passage ports 16 of the bed 14 itself.

The rotary elements 15 are all commanded through a motor reducer 23 and transmission means 24 for setting and maintaining the preset position of the elements 15 themselves during their rotation.

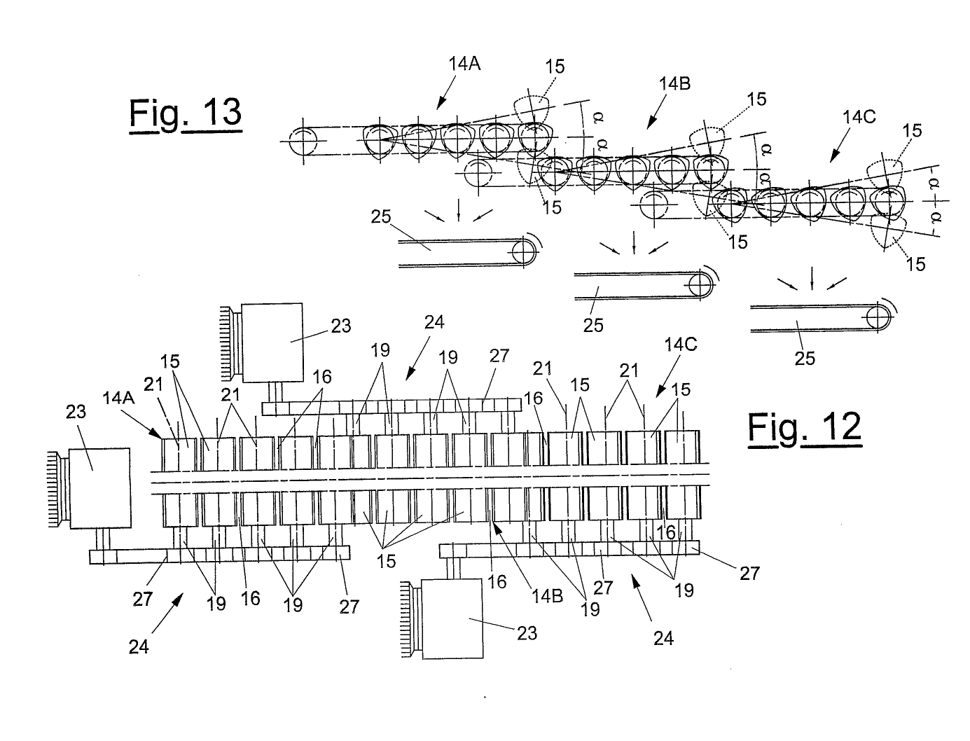

In FIG. 10 a transmission 24 with conical pairs of gears 26 is shown as an example, eliminated in FIG. 10 for the sake of simplicity. Alternatively, in FIGS. 12 and 13 transmission means 24 with belts 27, one for each branch 14A, 14B, 14C, are shown. Moreover, the transmission 24 could equally be carried out through a single chain or else a chain with tail sheaves or with worm screw system coupled with helical gears (not shown).

The non-homogeneous masses of material 11 fed onto the selection bed 14 are made to advance on it by the effect of the rotation of the rotary elements 15 with cam profile in a direction substantially perpendicular to the rotation axis 21 thereof and with transversal components according to the type of incision carried out on the rotary elements.

The portion of coarse material 11A, which is pushed to advance at a greater speed with respect to the finer portion 11B is thus discharged downstream of the bed 14.

During the transfer of the material on the selection bed 14 the particles of material of predetermined shape and size 11B cross the passage ports 16 between the adjacent rotary elements 15 and are collected in the space or spaces below 25 carrying out the classification, sieving and separation of the non-homogeneous mass 11 fed to the machine 10.

The variations in geometry of the rotary elements 15 with cam profile, as well as the surface incisions 22, can be specifically selected to move the specific type of material, be it wood-based or material of another nature, according to the predetermined criteria. Indeed, the geometric parameters of the classification, sieving and separation bed 14 influence the distribution and advance speed of the particles of different grain size.

The rotary elements 15 with cam profile give the material a pulsating energy transmitting different forces to the particles during each rotation. Moreover, given the upward slinging component given by the rotary elements 15 to the particles of material, the selection bed 14 can also be tilted upwards.

Moreover, increasing the agitation of the material advantageously increases the efficiency of the sieving and therefore the length of the bed necessary to obtain an end product of the desired quality can possibly be decreased. Indeed, by increasing the advance speed of the coarse portion with respect to the fine portion substantially reduces the volume of the material that occupies the sieving area defined between the rotary elements, promoting the efficiency of the system.

Another particularly positive effect is that determined by the forces applied to the coarse material during advancing that cause remixing thereof, promoting the detachment of the microparticles resting on the macroparticles.

The machine for the classification, sieving and separation of non-homogeneous masses of materials object of the present invention has the advantage of increasing the efficiency of classification, sieving and separation whilst still reducing the bulk of the plant.

A further advantage of the machine according to the present invention consists of the possibility of being adapted to the treatment of different types of material be they wood-based or other.

Another advantage of the machine according to the present invention consists of the modularity of the rotary elements that can have variable length, shape and surface characteristics.

The machine for the classification, sieving and separation of non-homogeneous masses of materials thus conceived is susceptible to numerous modifications and variants, which are all covered by the invention; moreover, all of the details can be replaced by technically equivalent elements. In practice, the materials used, as well as the sizes, can be whatever according to the technical requirements.

1. Machine for the classification, sieving and separation of non-homogeneous masses of materials comprising a feed (12) for said non-homogeneous masses (11) and a discharge (13) for a coarse portion of material (11A), respectively arranged at opposite ends of a selection bed (14) of said non-homogeneous masses (11), said bed (14) comprising a plurality of rotary elements (15) arranged adjacent to each other, suitable for determining the movement of the material, said rotary elements (15) being able to be spaced apart by a predefinable amount to define passage ports (16) for a portion of material (11B) of predetermined shape and size of said non-homogeneous masses, characterised in that said rotary elements (15) have a cross section with cam profile (17, 18) or variable radius, in other words having a different cross section to the cylindrical section, said cam profile (17, 18) being suitable for developing a sinusoidal peripheral speed of said rotary elements (15).

2. Machine according to claim 1, characterised in that a shared area between said two adjacent rotary elements (15) is cyclically variable, said rotation axes (21) being kept at a constant distance.

3. Machine according to claim 2, characterised in that said predetermined distance between the axes (21) of said rotary elements (15) can be less than the circle described in rotation by the outermost point of said cam profile (17, 18).

4. Machine according to claim 1, characterised in that said rotary elements (15) are all commanded in phase for a classification and sieving of said non-homogeneous masses (11) according to a narrow size range of said portion of material (11B) to be separated.

5. Machine according to claim 1, characterised in that said rotary elements (15) are commanded not in phase for a pulsating classification and sieving of said non-homogeneous masses (11) according to a range between a maximum and minimum size value of said portion of material (11B) to be separated.

6. Machine according to claim 1, characterised in that said rotary elements (15) comprise shafts (19), or substantially cylindrical cores, and at least one portion (20) having a cross section with cam profile (17, 18).

7. Machine according to claim 6, characterised in that two or more portions (20) having a cross section with cam profile (17, 18) are aligned along a rotation axis (21) of said portions (20).

8. Machine according to claim 7, characterised in that said portions (20) have different phasing, cross section and/or different surface incision.

9. Machine according to claim 1, characterised in that said rotary elements (15) are equipped with a smooth outer surface.

10. Machine according to claim 1, characterised in that said rotary elements (15) are equipped with an outer surface carrying incisions (22), or crests and valleys, of fixed or variable geometry.

11. Machine according to claim 10, characterised in that said incisions (20) have a rectilinear, oblique or helical progression.

12. Machine according to claim 11, characterised in that said incisions (22) are crossed.

13. Machine according to claim 10, characterised in that said incisions (22) form geometrically variable projections.

14. Machine according to claim 10, characterised in that said incisions (22) are different on at least two side faces of said rotary elements (15).

15. Machine according to claim 1, characterised in that said movement of said non-homogeneous masses (11) of material takes place according to an axis substantially perpendicular to a rotation axis (21) of said rotary elements (15) and with possible transversal components, produced by surface incisions (22) carried out on said rotary elements (15).

16. Machine according to claim 1, characterised in that said rotary elements (15) have at least one portion (20) having a cross section with cam profile (17, 18) with elliptical cross section (17).

17. Machine according to claim 1, characterised in that said rotary elements (15) have at least one portion (20) having a cross section with cam profile (17, 18) with substantially triangular or tri-lobed cross section (18).

18. Machine according to claim 1, characterised in that said rotary elements (15) can be laterally spaced according to a straight line, said selection bed (14) having rectilinear progression.

19. Machine according to claim 1, characterised in that said rotary elements (15) can be laterally spaced according to a broken line, said selection bed (14) having sinusoidal progression.

20. Machine according to claim 1, characterised in that said bed (14) comprises at least two branches (14A, 14B, 14C) at different heights.

21. Machine according to claim 1 or 20, characterised in that said bed (14) or said branches (14A, 14B, 14C) can be inclined by an angle equal to +/−α with respect to a horizontal plane.

22. Machine according to claim 1, characterised in that it comprises a motor reducer (23) and transmission means (24) for setting and maintaining the predetermined set constant rotation of the rotary elements (15).
